(19) United States
(12) Patent Application Publication
(10) Pub. No.: US 2007/0162318 A1
(43) Pub. Date: Jul. 12, 2007

(54) System And Method For Managing Business Processes

(75) Inventors: Rick Bean, Bethel, CT (US); Jim Bean, Southbury, CT (US); Jan M. Levine, East Norwalk, CT (US)

Correspondence Address: EDELL, SHAPIRO & FINNAN, LLC, 1901 RESEARCH BOULEVARD, SUITE 400, ROCKVILLE, MD, 20850, US

(73) Assignee: Kaulkin Information Systems, LLC, Bethesda, MD (US)

(21) Appl. No.: 11/557,663

(22) Filed: Nov. 8, 2006

Related U.S. Application Data
(60) Provisional application No. 60/734,298, filed on Nov. 8, 2005.

(51) Int. Cl. G05B 19/418

(52) U.S. Cl. 705/8

(57) ABSTRACT

A business process management system includes a computer system is disclosed. The computer system is accessible via a network that manages access by users to documents, enables dynamic generation of a workflow process by a user, executes and monitors the workflow and maintains information about the workflow, and enables integration of a combination of e-mail, advertising copy, instant messaging, and electronic funds transfer functions into the generated workflow process.

### CROSS REFERENCE TO RELATED APPLICATIONS

This application claims the benefit of a Provisional Patent Application No. 60/734,298, filed on 8 Nov. 2005, entitled “Data Storage and Retrieval System”. The disclosure of the aforementioned application is incorporated herein by reference in its entirety.

### FIELD OF THE INVENTION

The present invention relates to a system for managing business processes and, in particular, to a data storage and retrieval system.

### BACKGROUND OF THE INVENTION

When deploying a business process management system, the primary development bottleneck is typically the user having to explain to an unsympathetic IT analyst what it is that the workflow must comprise. This often takes months of review meetings because the IT specialists have no idea as to what the actual workflow requirements may be. When the IT specialists eventually believe that they do understand the requirements, they locate vendors who will meet each set of needs as well as the needs of the many others in the business who intend to use the system. Tests, trials, etc., ensue, and after many designs and re-designs, a solution is proposed and demonstrated. Typically, these solutions deal with approximately 75-80% of the problems, rendering the real effectiveness of the workflow as a series of compromises. Changes after the initial implementation take additional time, and even then the final product rarely addresses all the needs of the system. Thus, it would be desirable to provide an on-line data collection and management system for use in business process management that is completely managed by the end users of the system as opposed to, and without the need for, in-house or outside IT specialists.

### SUMMARY OF THE INVENTION

The present invention is directed toward an on-line data collection and management system for use in business process management. The system includes a computer system accessible via a network. The computer system is configured to manage user access to documents, enable dynamic generation of a workflow process, execute and monitor the workflow process, maintain information about the workflow, and enable the integration of a combination of e-mail, advertising copy, instant messaging, and electronic funds transfer functions into the generated workflow process.

The system is completely managed by the end users of the system. User management includes the ability to add users, add new index values, immediately grant access to data on a world-wide (temporarily or permanently) basis, and create, manage and alter routes for workflow components. Unlike other workflow or business process management systems, stops along the workflow route can be any computer person, located anywhere in the world, that has Internet access.

The system utilizes a semi-automated indexing system wherein the user chooses any unique value from a drop-down menu (such as an account number or Social Security Number), and the system immediately populates any of the dozens of index values that are in the database prepared for the company/client. All documents are then cross-indexed, and therefore retrievable, by all or any of those values. The system includes downloading methods that allow for almost instant access to data fields. Even when used over the Internet, the system is faster than local area networked applications. In addition, the system includes an Internet data import capability (e.g., using .Net). As a result, the system can securely accept large amounts of data over a standard Internet connection.

There are numerous advantages deriving from the strength of the customized approach and training methods of the present invention. With the present invention, persons using the workflow develop it on the fly and can immediately see where it is not working, quickly point and shoot to a few changes, and re-test. This entire process takes minutes, or a few hours at most, as opposed to several months. In addition, due to the design of the invention's ‘toolkit’ approach, every system created according to the invention is 100% customized for each new client and this is done at a fraction of the cost that others, if they can do it at all, would need to charge. The result is that the invention permits deployment of a world-wide, world-class business process management system in a few days, not several months. Further, the training methodologies that were developed, and the simplicity of the system, allow for complete user training in minutes.

### BRIEF DESCRIPTION OF THE DRAWINGS

FIG. 1 illustrates a hardware diagram of a business process management system according to an embodiment of the present invention.

FIG. 2 illustrates a hardware diagram for redundant facility of the business process management system of FIG. 1.

FIG. 3 illustrates a flow diagram for system sign-on and file uploading procedures in accordance with an embodiment of the invention.

FIG. 4 illustrates a flow diagram for a batch uploading process in accordance with an embodiment of the invention.

FIGS. 5A-5C illustrate the workflow module in accordance with an embodiment of the invention. Specifically, FIG. 5A illustrates a flow diagram for creating a workflow/workbasket. FIGS. 5B and 5C illustrate dialog boxes utilized in creating the workflow/workbasket.

FIGS. 5D-5F further illustrate the workflow module in accordance with an embodiment of the invention. Specifically, FIG. 5A illustrates a flow diagram for adding users to a workflow/workbasket. FIGS. 5A and 5B illustrate dialog boxes utilized in adding users to the workflow/workbasket.

FIG. 5G further illustrates the workflow module in accordance with an embodiment of the invention, showing a flow diagram for modifying a workbasket/workflow.

FIG. 6A illustrates a flow diagram of a workflow route in accordance with embodiment of the present invention.

FIGS. 6B and 6C illustrate dialog boxes used in the workflow route of FIG. 6A.

FIG. 7A illustrates a flow diagram showing the process for a user to modify a workbasket in accordance with an embodiment of the present invention.

FIG. 7B illustrates the flow char for retrieving and displaying workbasket information in accordance with an embodiment of the present invention.

FIGS. 7B and 7C illustrate dialog boxes used in the retrieval and display processes of FIG. 7B.

FIG. 8 illustrates a flow diagram showing a document retrieval process in accordance with an embodiment of the invention.

FIGS. 9A-9D illustrate the workflow edit request function of the business process management system in accordance with an embodiment of the present invention. Specifically, FIG. 9A is a flow diagram of the editing process, and FIGS. 9B-9D are exemplary dialog boxes utilized during the process of FIG. 9A.

FIG. 10A illustrates a diagram of system administrator functions in accordance with an embodiment of the invention.

FIGS. 10B-10H are exemplary dialog boxes utilized during the administrator functions of FIG. 10A.

FIG. 11 illustrates a diagram of administrator selected system defaults in accordance with an embodiment of the invention.

FIG. 12A illustrates a flow diagram showing the cash tracking module in accordance with an embodiment of the present invention.

FIGS. 12B-12C are exemplary dialog boxes utilized during the cash tracking module of FIG. 12A

FIGS. 13A and 13B illustrate flow diagrams showing the mail tracking module in accordance with embodiments the present invention.

FIG. 13C are exemplary dialog boxes utilized during the mail tracking module of FIGS. 13A and 13B

FIG. 14 illustrates a flow diagram showing the ad tracking module in accordance with an embodiment the present invention.

FIG. 15A illustrates a flow diagram showing the file tracking module in accordance with an embodiment the present invention.

FIG. 15B is an exemplary dialog box utilized during the file tracking module of FIG. 15A.

Like reference numerals have been used to identify like elements throughout this disclosure.

### DETAILED DESCRIPTION OF THE INVENTION

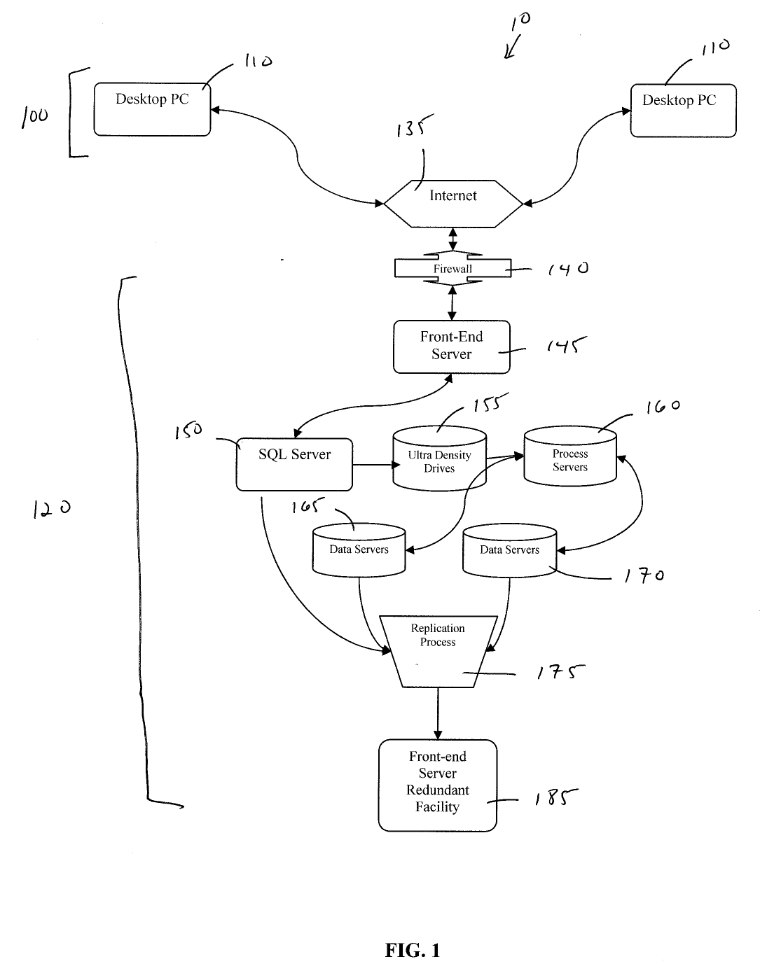

An exemplary hardware diagram of business process management and data collection system according to the present invention is illustrated in FIG. 1. As shown, the business process management/data collection system 10 includes (1) a client site 100 (also called a remote site) including a client computer system 110 and (2) a host site 120 (also called a service provider site) including a host computer system 125 (also called a central database system) in communication with the client computer system 110.

The client computer 110 may be any conventional personal computers, or can be larger capacity computers when the data processing requirements necessitate increased processing power. The computer is accessible via a network. For example, the client computer 110 may include any desktop PC capable of connecting to the Internet 135. By way of specific example, the client computer 110 may be a conventional IBM (WINDOWS) compatible or other type personal computer preferably equipped with a monitor, a base (i.e., including the processor, memory, and internal or external communication devices, ports or modems), a keyboard, and a mouse. The client computer 110 also includes the appropriate software to perform business system management as described below. The client computer 110, moreover, may utilize any of the major platforms or operating systems such as WINDOWS.

The client site 100 may communicate with the host site 120 over the Internet 135 via a communication link. Any communication link may be utilized to connect the client site to the Internet 135. By way of example, the communication link may include a DSL connection, a cable modem connection, a dial-up connection (phone lines), a wireless connection (e.g., satellite), and combinations thereof. Information can be sent using transmission methods may include HTTPS SSL connectivity (e.g., Port 443 of the internet, which encrypts transmissions). In this manner, the client site 100 (i.e., the client computer system 110) communicates with the computer system 125 of host site 120 via the Internet 135.

The host computer system 125 may include a firewall 140 and a front-end server 145. The computer system 125 of the host site 120 may further include a relational database management system 150 (e.g., a MICROSOFT SQL Server) in communication with both a storage device 155 (e.g., an ultra density storage device such as an ultra density drive) and a file/metadata replication system 175. The storage device 155 communicates with a process server 160, which, in turn, communicates with one or more data servers 165, 170. The data servers 165, 170, moreover, communicates with the file/metadata replication system 175, which stores a back-up copy of any information processed by the host computer system 125.

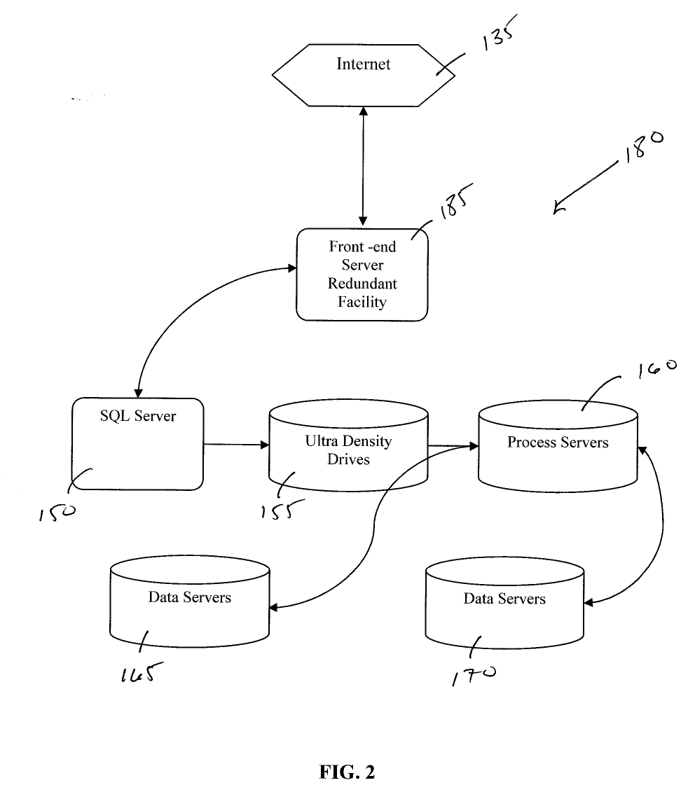

The host computer system 125 may further include a redundant facility 180 to prevent the loss of files/metadata should the host computer system 125 fail. FIG. 2 is a hardware diagram of the redundant facility in accordance with an embodiment of the invention. As illustrated, the redundant facility includes a computer system similar to that of the host computer system 125. Specifically, the redundant facility 180 may include a communication link that communicates with the host computer system 125 via the internet 135 in a manner similar to that described above. The redundant system further includes a redundant front end server 185, a redundant relational database management system 150 (e.g., a MICROSOFT SQL Server), a redundant storage device 155, as well as redundant process 160 and data servers 165, 170.

With this configuration, the host computer system 125 can process (upload, download, and store) files and metadata to/from the client computer system 110. In operation, all files and metadata pass through the firewall 140 and are received at the front-end server 145. The files and metadata may be stored using the relational database management system 150, which links filenames with a matching file id. All files are then written to the storage device 155, and are given auto-incremented numeric names, which are pushed into numeric dated sub-directories (i.e., the process and data servers 160, 165, and 170). All metadata and files are then immediately replicated via the replication system 175 and transmitted to the redundant facility.

Utilizing the present system 10, clients may define workflow parameters to manage business processes. Specifically, the parameters control the route of a workbasket, directing the workbasket to client personnel in a predetermined manner. The workflow parameters may be defined by a client administrator, providing individual users with selective access to files present on the system based on, for example, the occurrence of specified events. The workflow parameters include a default library of predetermined index values created and arranged by the host site 120.

The index values present data fields to the client personnel that are created dynamically from the setup information contained in the database into which a user is signed. There may be two distinct types of data presented to the user. The first type of data is Tier Data. This type of data is presented as a series of combination boxes with select values that are hierarchically dependent on one another. For example, when a user is uploading data, if the user selects data in the top level combination box, the second level combination box will only display data relative to the data which was selected in the top level. Alternatively, the system may be configured to display all values show (e.g., when downloading/retrieving data). This scheme follows for all levels of combination boxes, and applies to both the data collection and retrieval processes utilized by the system. Tier Data is defined and maintained by a client administrator via an administration module function of the software.

The second type of data is Common Index Data. This Common Index Data can be presented to the user in various display types including combination boxes with select criteria defined by the client administrator, text boxes, and date fields.

The workflow management/data collection system 10 also provides a facility to view all records for a particular level (e.g., at the File Upload Control, discussed in greater detail below). Thus, if the user clicks the right mouse button while over a particular level combination box, the user is presented with a list of all possible values for that level regardless of parent levels. Once the user selects a value, all the parent levels are filled in automatically with the first value that contains the correct hierarchy for the child level. This functionality exists without round trips to the server. All the data, moreover, is contained locally on the client computer system 110 at the time of selection. Thus, the software presents data with minimal delay to the end user/client, even with large amounts of selection data. The HTML for the combination boxes and select values are dynamically generated with each selection change.

The software of workflow management/data collection system 10 also provides an historical Auto Fill function. This software feature automatically populates all of the control parameters (both Tier and Common Index) based on data previously uploaded. In operation, a user may fill in any number of controls, then click a button to retrieve all the historical records (from their specific on-line database) that contain the values, which the user/client has filled in, and populate the remaining controls based on historical uploads. Using conventional navigational icons and functions, the user can cycle through all of the matching history. Each historical record will fill in all the relevant controls that were present for that historical upload. This historical cycling feature may utilize MICROSOFT .NET functions. All of the history that the user has selected is brought down to the client site 100. Thus, a user is able to cycle through the history with minimal delay.

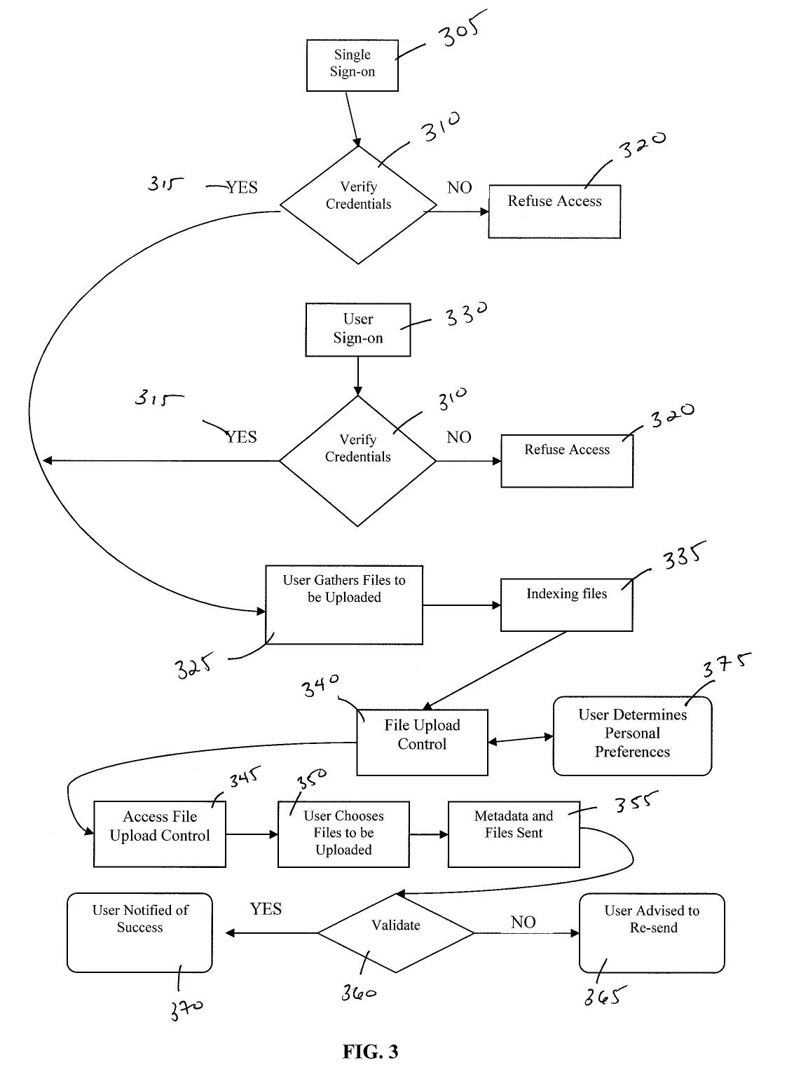

The operation of the system is explained with reference to FIGS. 1-15. FIG. 3 is a flow chart for system sign-on and file uploading procedures. As shown, a user or client may access the system (i.e., a user may gain Internet access) using two different methods. The first method provides for a single sign on 305, wherein an XML form is received from the client's access control system each time one of the client users requires access. Credentials are verified 310 against a previously submitted stop and verified list of users (new users are added as needed) from the client. If credentials are not approved, access is refused (Step 320). If credentials are verified 315, then access is permitted and file processing may begin 325.

The second sign-on method provides an individual user sign-on 330. Here, the user is required to enter specific information (e.g., a predetermined a six digit client code, a username, and a password with a predetermined password string). This information is maintained by the client/user utilizing a preferences setting (discussed in greater detail below). As with the above process, if password is not accepted, access is denied (Step 320). If the password is verified 315, access is permitted and file processing may begin 325.

Once the system 10 is entered, the level of file access a user is provided depends on the level of security code clearance given, as assigned by the client administrator. Thus, once a user signs on, access to specific modules (and files) will be limited to those for which approval has been granted (discussed in greater detail below).

After signing on, the user may interact with the system 10 to manually upload individual files onto the host site 120. To upload files, the user first gathers files for uploading (Step 325). The method of uploading, as well as the type of file that may be uploaded, is not particularly limited. For example, the client/user may scan a file into the local hard drive or any local network. Alternatively, the user may attach media or digital files (e.g., MICROSOFT WORD files) from the local drive/network. Once files are gathered, the files are indexed at 335 utilizing a series of predetermined index values created by the client administrator.

At Step 340, the system implements a file upload control. This control may be written using MICROSOFT .Net platform. The upload control may be a conventional interface such as a dropdown menu (e.g., an “Internet Explorer” styled control). This permits the user/client to choose as many files as desired from their local environment that needs to be uploaded to the server. In addition, a default directory may be displayed that can be quickly changed to find files on any other available drive on the user network.

The user or client accesses the file upload control 345 and chooses the files to upload 350. Then, the data from the web page (e.g., the Tier and Index data) are uploaded to the server 150 at the host site 120, along with the selected files 355. All the data and files are validated by the server at Step 360. If any problems exist, none of the data is uploaded 365 and the user is advised to re-send the data. If the files are validated, the user is notified the upload was successful 370.

The file upload control 340 further enables a user to configure various parameters for various behaviors of the file upload, as shown at Step 375. Such parameters may be established for each authorized user on the system. For example, the user can specify (1) to delete the files from their local environment upon successful upload to the server; (2) whether or not to save and use default data for the Tier and Index controls; (3) default data selection options (e.g., to use or not use default data, to use initially chosen data as a default template for all future uploads until these values are changed and saved again, to show each index value with an option to use defaults or not use defaults, and or indicate date-formatted fields should use the current date).

When manual indexing of large numbers of files (with their associated metadata) is not practical, the software of the business process management system 10 further permits a client to upload/index large batches using a single command. Large batches of files and their associated index data can be securely imported in a .Net environment directly over the Internet. The present invention contains a separate application allowing a client to upload batches of documents with their associated index data values. FIG. 4 illustrates a flow chart of the batch uploading process. In the process, the client initially presents a data map 400, and then gathers files for upload 405 by specifying any number of documents containing any number of files. The user then sends the files via a secure FTP or directly over the internet at to the server 150 at Step 410. For example, the files may be securely imported using XML over the Internet.

The files are indexed 415 in a manner similar to that described above (i.e. the system indexes all received data into a specified TrackFile SQL database). Once indexed, each record in the batch file contains the predefined data (defined by the client administrator utilizing an administrator module, discussed below), including the filenames of the files to be associated with the data of that specific record. The files batch is validated 420 on the server against the original data map and files received. If any problems exist, none of the data is uploaded 425. If no problems exist, the user is notified the upload was successful 430. When uploaded, all the received files are written to the data server 435 using the index values applied (in Step 415). In addition, the data files are immediately replicated 440.

The configuration parameters used by the system 10 to index uploaded files include, but are not limited to:
url—The url to the web service which will process the upload. This defaults to the production web service.
timeoutminutes—The user may specify the amount of time to wait for an upload to be completed.
companycode—The company code to used for the upload. If this is not specified in the configuration file, the user is prompted to enter it.
userid—The TrackFile user id (for the given companycode) to use for the upload. If this is not specified in the configuration file, the user is prompted to enter it.
password—The password for the user. If this is not specified in the configuration file, the user is prompted to enter it.
testmode—Indicates to simply check the connectivity and configuration. Data is not uploaded to the server.
datafilename—The full location and name of the data file to process.
datadelimiter—The field delimiter for the data file records.
displaynames—The list of the Tier and Index fields which data will be loaded to. This list will be delimited by the “datadelimiter”. Each record in the data file will contain a data delimited list of values which will correspond exactly to this list of displaynames. Following the list of values will be a delimited list of file names which will be associated with the field data of the record.
firstlinetoprocess—The record number of the first line of the data file which the user wishes to process. If not specified, this will default to the first record of the file.
lastlinetoprocess—The record number of the last line of the data file which the user wishes to process. If not specified this will default to the last record of the file.
asktocontinueonerror—If an error occurs the user can choose to be notified and given the opportunity to stop the batch or continue processing the remaining records.

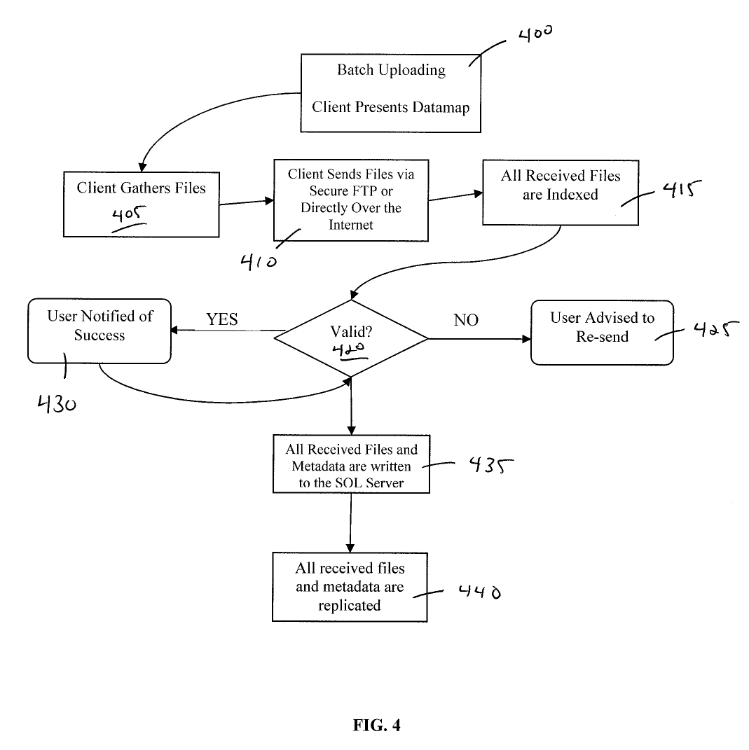

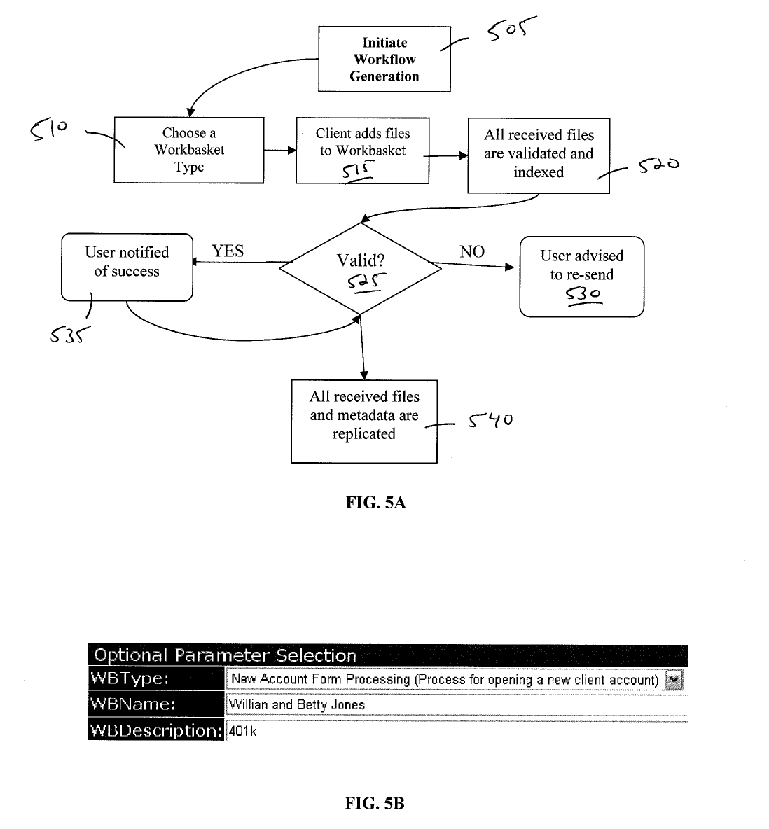

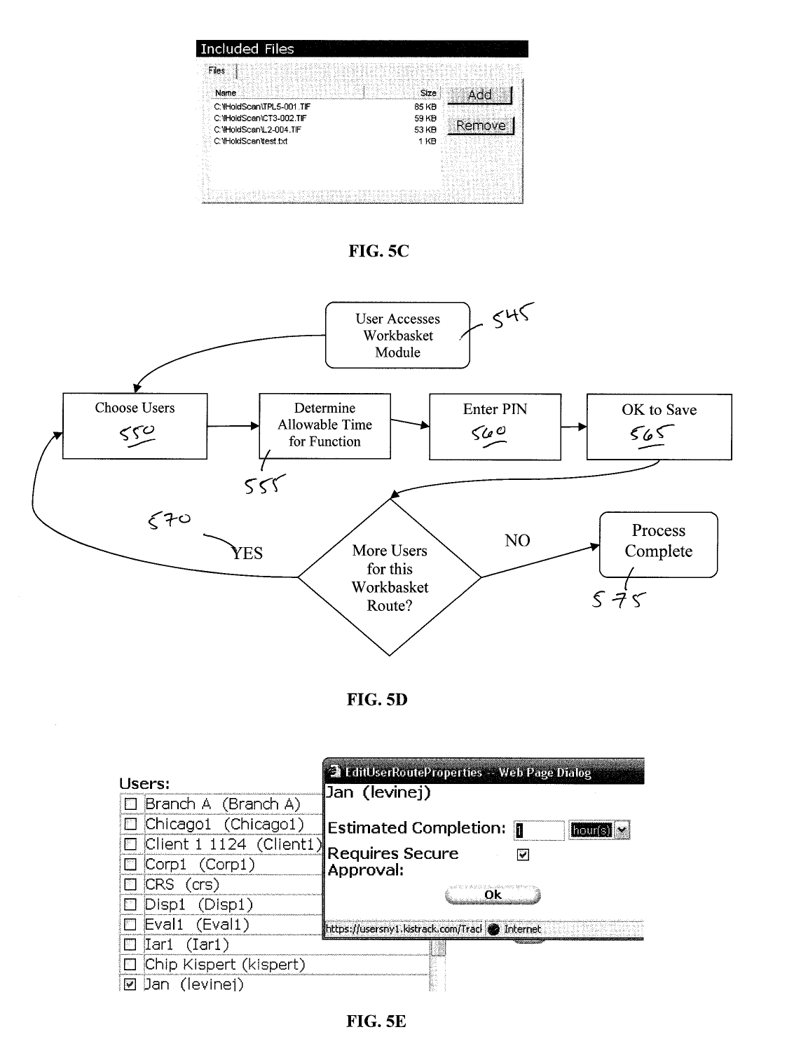

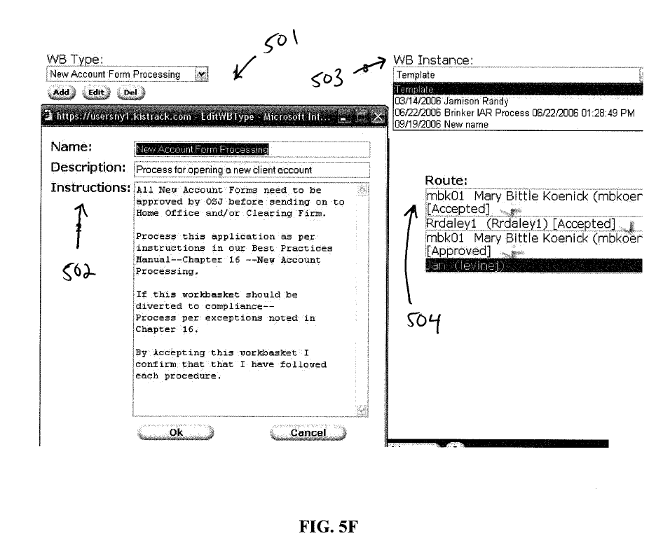

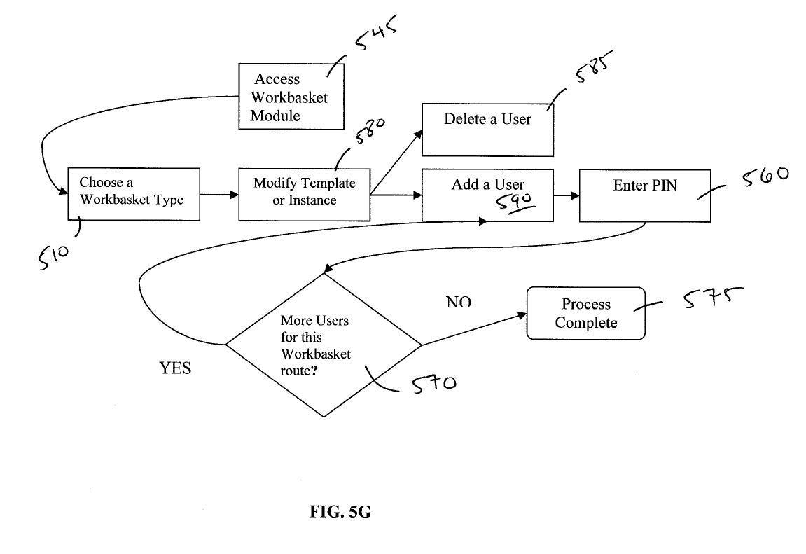

The software of the business process management system 10 further uses the act of scanning a paper document or uploading a digital file (existing anywhere within the computing network or auxiliary storage media such as DVDs) into its archive system as the means of starting a particular process or workflow. FIGS. 5A-5F illustrate the various workflow modules. Referring to FIG. 5A, the user may access the workflow module 505 to initiate the workflow feature. The user chooses a workbasket type 510 from a drop down menu (the menu includes index values as defined by the administrator) and entering a name for the workbasket into the appropriate field, as illustrated in FIG. 5B. The workbasket includes the work to be performed during the workflow (i.e., it explains the workflow route). If the name field is left blank, the system 10 assigns a name based upon the time and date created.

The user/client may then add files to the workbasket 515 by simply attaching the files from, e.g., the local drive as illustrated in FIG. 5C. All received files are indexed 520 in a manner similar to that described above (all files are instantly cross indexed by all index values). For example, if the document is a PDF or TIF file, optical character recognition techniques may automatically be applied as a background operation, so as not to affect the availability of the now indexed and archived data files and images. The content of every cell in a spreadsheet, every word in a word-processing document and every label or a presentation file will be placed into a full-text searchable database, along with the output value of the above documents. This file set also has started a workbasket route (also called a workflow route). The files are then validated 525 by the host site 120. If any problems exist in the files, none of the data is uploaded 530. If no problems exist, the user is notified the upload was successful 535. All received files and metadata are then replicated via the replication facility 540.

An exemplary process for creating a workbasket is illustrated in the flow chart of FIG. 5D. A workbasket route may be created by a client administrator. As shown, the client administrator accesses the workbasket module 545. The client administrator chooses one or more client personnel to receive the workbasket 550. Choosing more than one personnel member results in parallel processing for those members. If only one member is selected, the route will be processed serially. The client administrator may then determine/set the allocated time to complete the particular task 555, as well as enter a secure PIN code (if necessary) required to move the workbasket along its route (Step 560). Once saved 565, the client administrator may add further additional users to the route (Step 570) until complete (Step 575). An exemplary menu to enter the above-described information is illustrated in FIG. 5E.

In this manner, the route of a workbasket may be monitored and tracked. FIG. 5F illustrates the workbasket information display according to an embodiment of the invention. As illustrated, the workbasket type (referenced as 501) and the description (referenced as 502) of the workbasket may be entered in the appropriate field. In addition, action items along the workflow route (called ‘instances’ 503 of the workbasket) may be selected to display the ‘route’ 504 of the workbasket, along with the status of the workbasket (e.g., accepted, approved, or remain open). If the route of the workbasket is still open, new stops may be added, if necessary. Alternatively, workbaskets that are closed are locked and can not be altered. With this configuration, the system allows approval control and auditing capabilities that assists the clients to stay in compliance with accountability rules and regulations imposed on U.S. businesses.

A workbasket may also be modified to accommodate client needs. FIG. 5G illustrates a flow chart showing modification of workbasket in accordance with an embodiment of the invention. First, a user accesses the workbasket module 545 and chooses a workbasket type (Step 510) in a manner similar to that described above. At Step 580, the user selects to modify either a template or an instance of an existing, uncompleted workbasket. A client may then either delete client personnel 585 or add client personnel 590 to the workbasket. Once client personnel are modified, the administrator may then choose whether a secure PIN code will be required to move this workbasket along its route 560 as described above. Furthermore, as explained above, the client administrator may then add additional users to the route 570 or terminate the modification process 575.

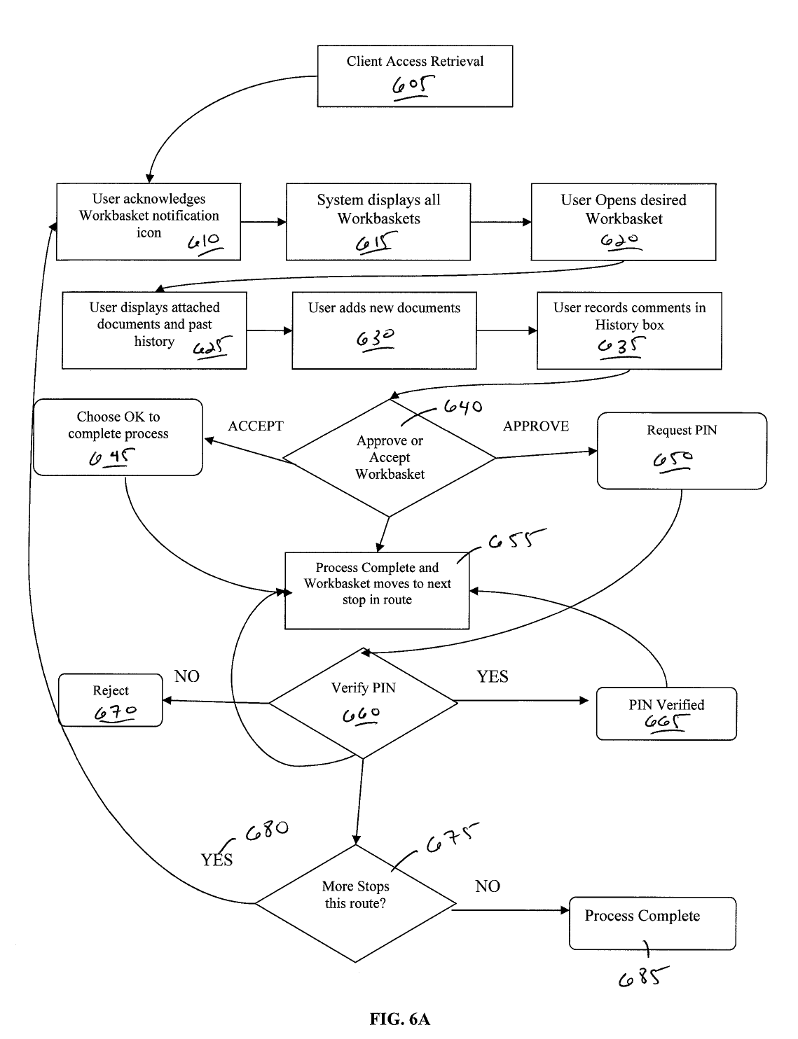

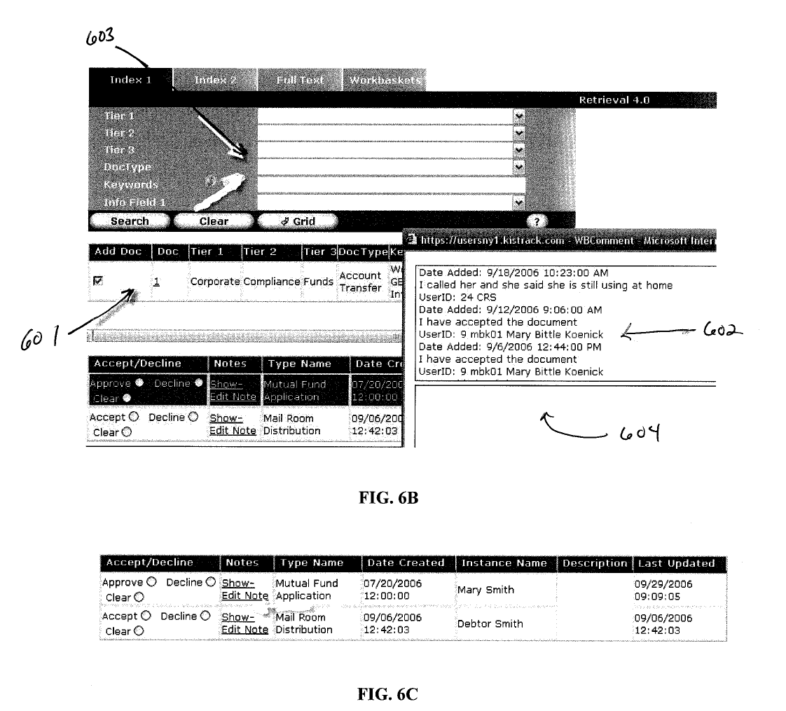

FIGS. 6A-C illustrate the workbasket management functions of the system 10. Referring to FIG. 6A, showing a flowchart for managing user workbaskets, the act of sending any file into a workbasket initiates a process wherein the first member of the client personnel listed in the route is instantly sent a workbasket notification (e.g., an email) that a new workbasket has been created (Step 605). The notification may include further indicators (audible, visual, etc.). When the message is received, the personnel member acknowledges the workbasket notification 610, and the system 10 displays all workbaskets that require an action 615. An exemplary menu for providing the personnel notification is shown in FIG. 6B.

The personnel member (user) can open the workbasket to view its notes and documents 620, thereby opening an option screen, an embodiment of which is illustrated in FIG. 6B. Choosing the document (DOC) number will open the file in its native format 625 (referenced as 601 in FIG. 6B) and can view all previous activity on this workbasket (the field showing previous activity is referenced as 602 in FIG. 6B). At Step 630, the personnel member can add documents to this workbasket to be passed along to the next stop in the route (in the field referenced as 603 in FIG. 6B). In addition, at Step 635, the personnel member may record any comments relating to the workbasket in a blank field (referenced as 604 in FIG. 6B).

Then, in Step 640 (FIG. 6A), the personnel member can either accept or approve the workbasket. An exemplary menu for opening, approving, and/or accepting the workbasket is illustrated in FIG. 6C. If the workbasket is accepted (Step 645), the process is complete and the workbasket moves to the next stop in the route (Step 655). If approved, a PIN is requested 650, and a PIN verification process occurs 660. If the PIN is not verified, approval is rejected 670. If the PIN is verified (Step 665), the workbasket will instantly move to the next personnel member in the specified route 655, once the active personnel member chooses to save all modifications. In addition, the system 10 queries whether additional stops exist along the route 675. If additional stops exist 680, the process proceeds back to Step 610, reinitiating the process. If no other stops exist 685, the process is completed.

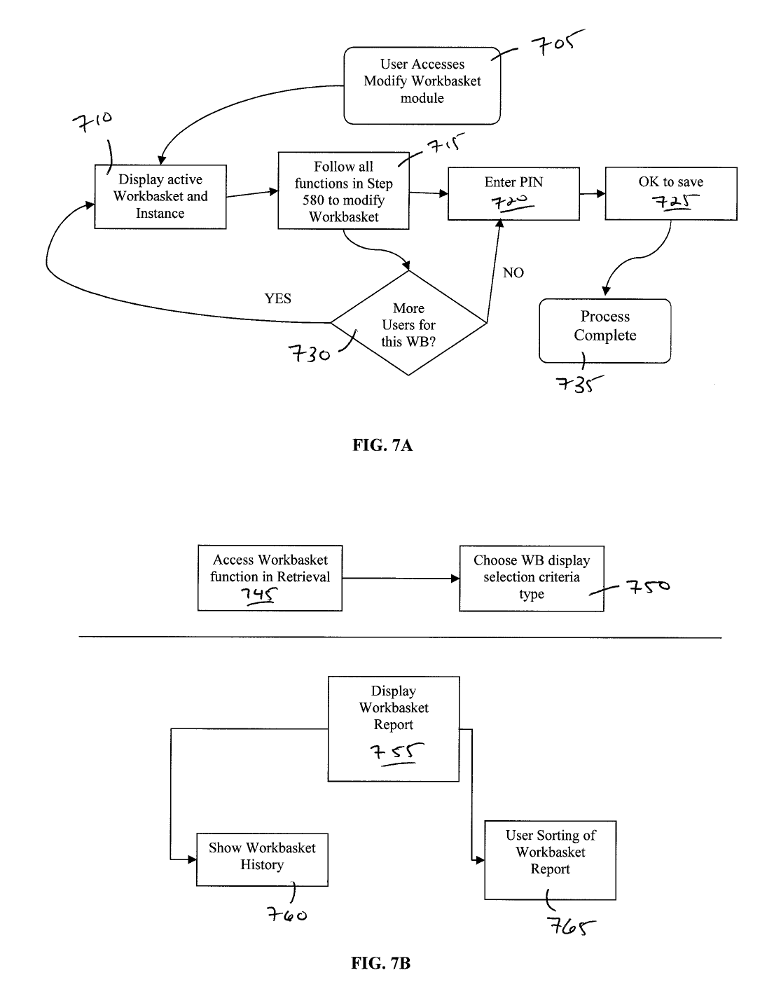

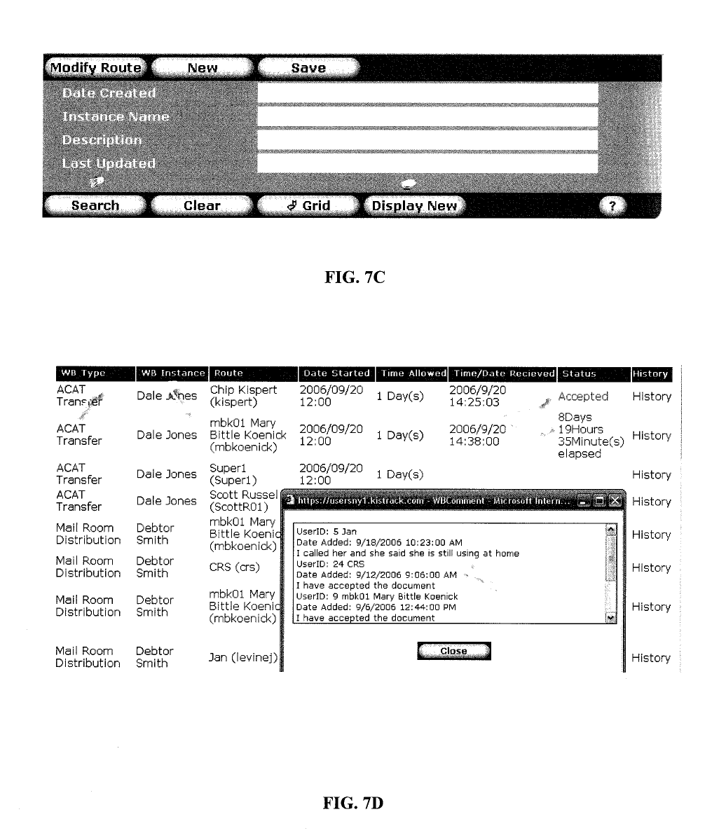

FIGS. 7A-7D illustrate the rerouting, search, and display functions of the system 10. Referring to FIG. 7A, a user/personnel member may request a change in a workbasket and/or route after the workbasket has been created and a route defined. It is important to note that users may be provided with defined levels of access to modules of the system 10. Thus, in order to modify a workbasket, a user may require authorization (as established by the client administrator), i.e., a security clearance. Initially, the personnel member (with appropriate administrative clearance) chooses the modify workbasket function 705 of the Workbasket Module. The software displays active workbaskets 710. The user is taken to the workbasket routine 715, with the specific workbasket type and workbasket instance displayed. The user then follows all procedures as described above (with reference to FIG. 5G, above) until all appropriate steps in the route modification are completed. For example, the number of personnel member in a given route may be modified in Step 730. Once all modifications have been performed, a PIN is entered 720, the modifications are saved 725, and the process is completed 735.

As shown in FIGS. 7B-7D, users can search for and display workbaskets by choosing values including, but not limited to, the date the workbasket was created, instance name, description or last updated. An exemplary search form is shown in FIG. 7C. The user accesses the workbasket retrieval 745 and then chooses a workbasket display criteria 750. Referring to FIG. 7D, users can also view a real time report that shows the status of every stop of every instance of every open workbasket (Steps 755, 760, 765 in FIG. 7B).

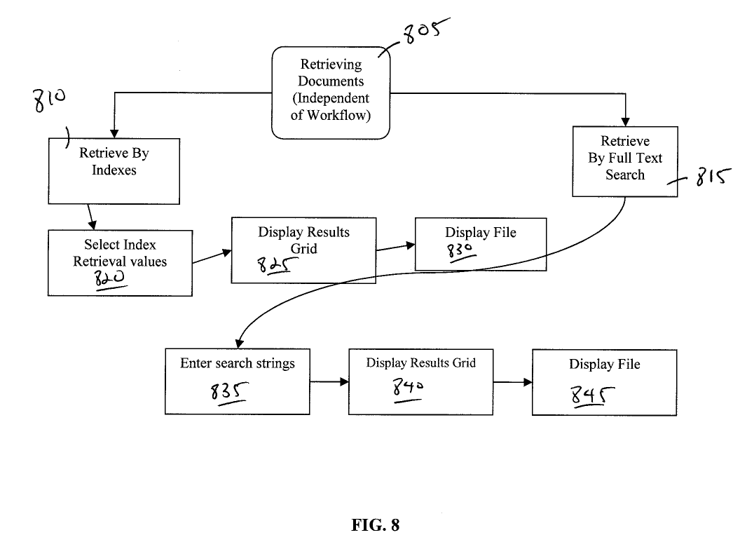

The system 10 also includes a document retrieval function, an embodiment of which is illustrated in FIG. 8. To access the function, the user chooses the retrieval module 805. The user then either designates whether to retrieve the desired fields using Tier Data and Index values 810, or to retrieve using a full text search 815. If the search is performed using Index values 810, the user selects the values 820, and the files meeting the Index values are displayed (Step 825). The user may then access each of the results, displaying a particular file 830. For example, by choosing a document (DOC) number, the file is displayed in its native format (e.g., WORD, portable document format, etc.).

To locate files using full text searching 815, the user simply types in any combination of words, phrases, dates, or numeric values 835 into a text search field. The user then displays results 840, displaying the desired file 845 in is native format.

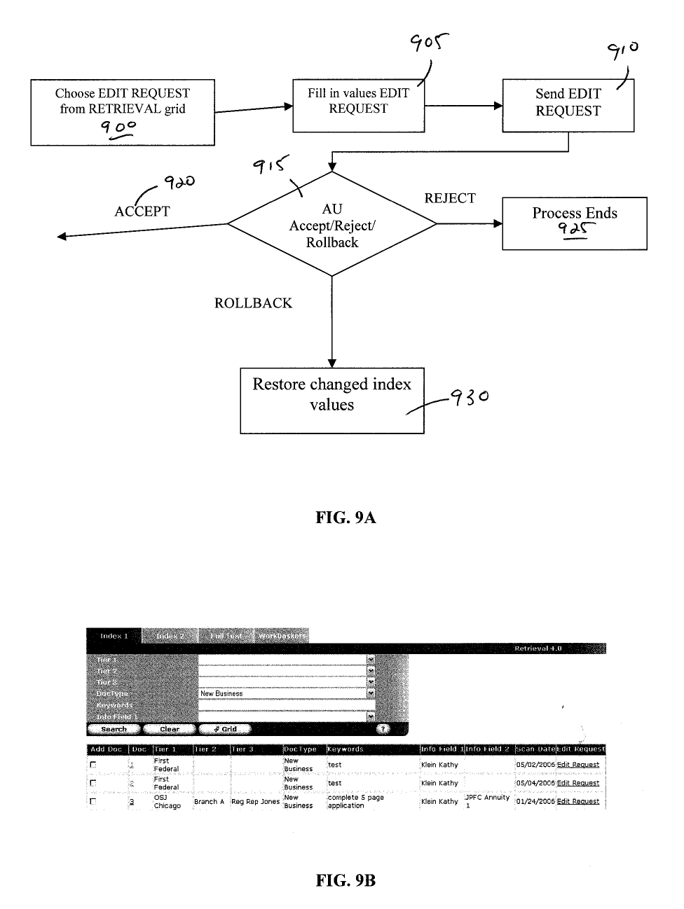

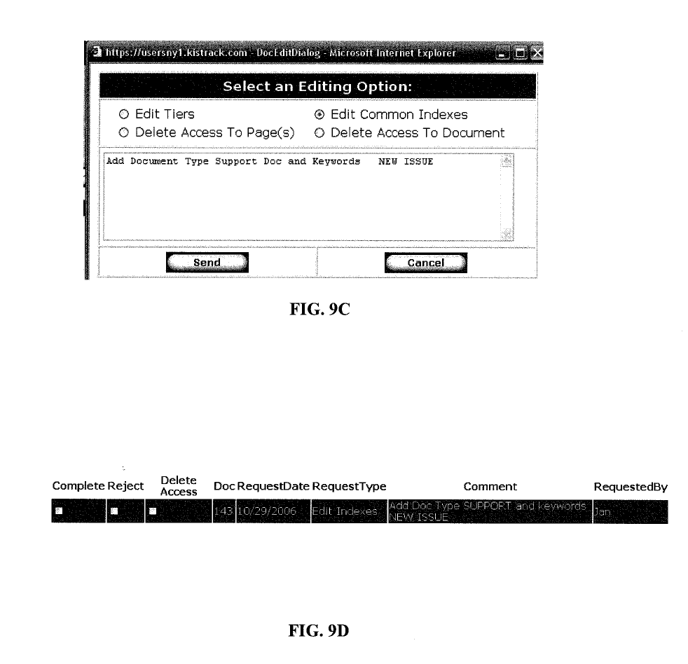

The system 10 enables each personnel member (user) to request that the client administrator change/redefine the Index or Tier values. The process steps for modifying Index/Tier values is shown in FIG. 9A. Initially, at Step 900, a user accesses the Edit Access function from the Retrieval Grid (illustrated in FIG. 9B). The user has the capability of informing the Administrator that access to particular files needs to be changed (Steps 905, 910) using, e.g., the form illustrated in FIG. 9C. At Step 915, the client administrator can either accept 920, reject 925, or rollback 930 the request using the form illustrated in FIG. 9D. If the request is accepted, the change to the Index/Tier values will be added. If the client administrator rejects the change request, the request will be deleted from the grid when the next save is performed. In addition, at anytime the Administrator can put in a written request to restore any/all previous versions, even if it is presently hidden from view, i.e., the client administrator may automatically roll back to the pervious versions of the workbasket.

As mentioned above, the system 10 further includes an administration module that enables the client administrator to manage all activities. In operation, one or more primary client administrators may be defined at the time the client database is created. For example, hard coded into the SQL database may be the name of a senior officer involved with the project (who must be in a position of higher internal company responsibility) may be appointed primary client administrator. The primary client administrator may add other, secondary client administrators, as needed. The system may be further configured to send an email to the primary client administrator whenever a secondary administrator is added to the system 10. This feature helps maintains compliance and legal audibility. The client administrator (primary and/or secondary), moreover, can define personnel groups, defining the level of access each group has to selected portions of the Tier structure.

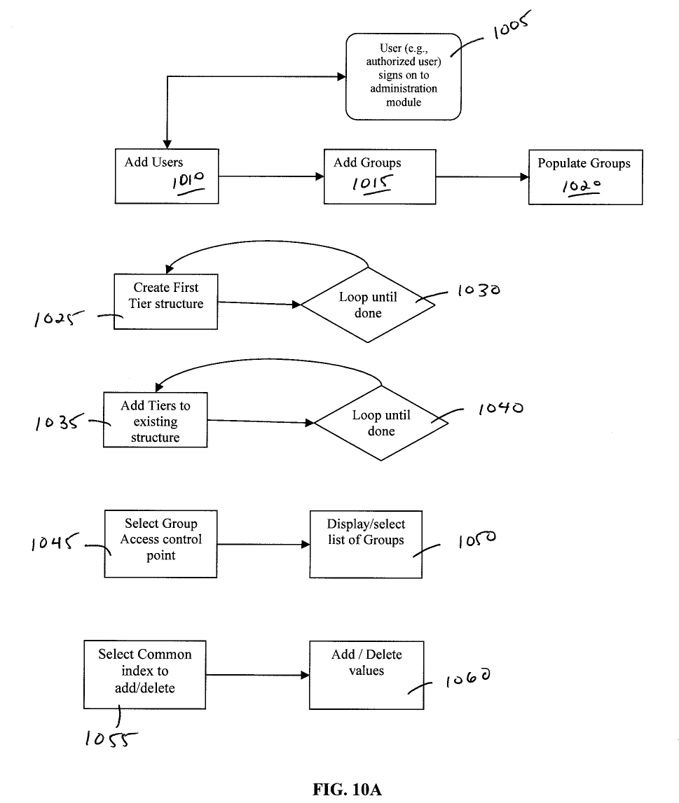

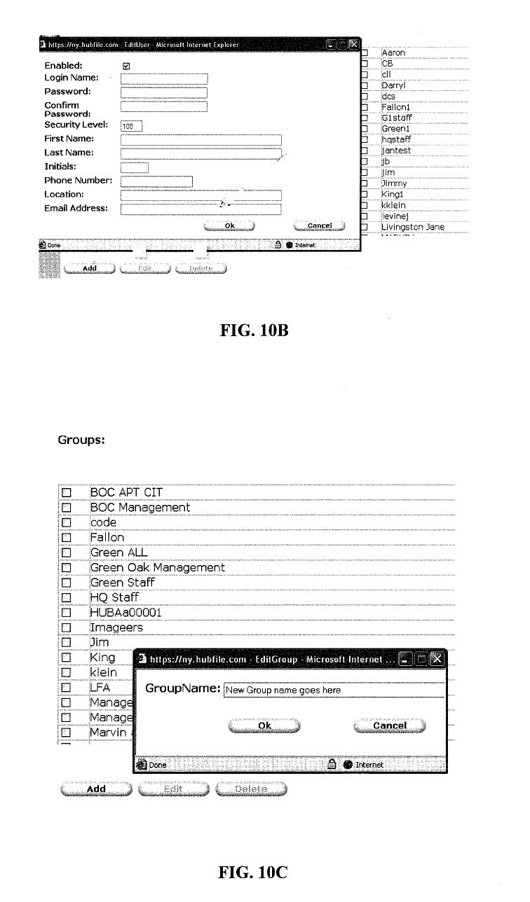

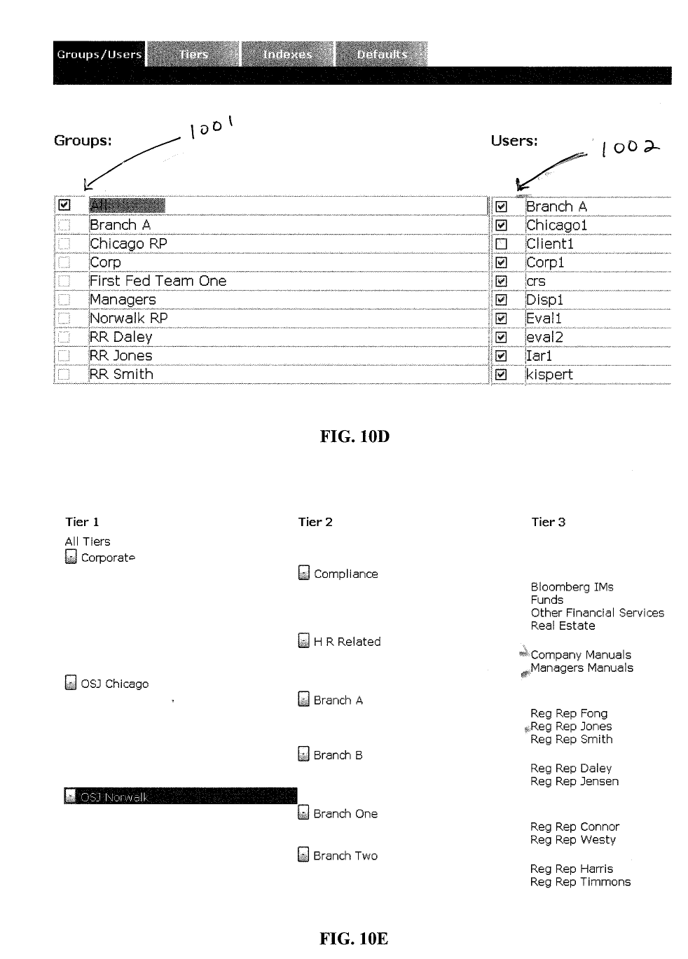

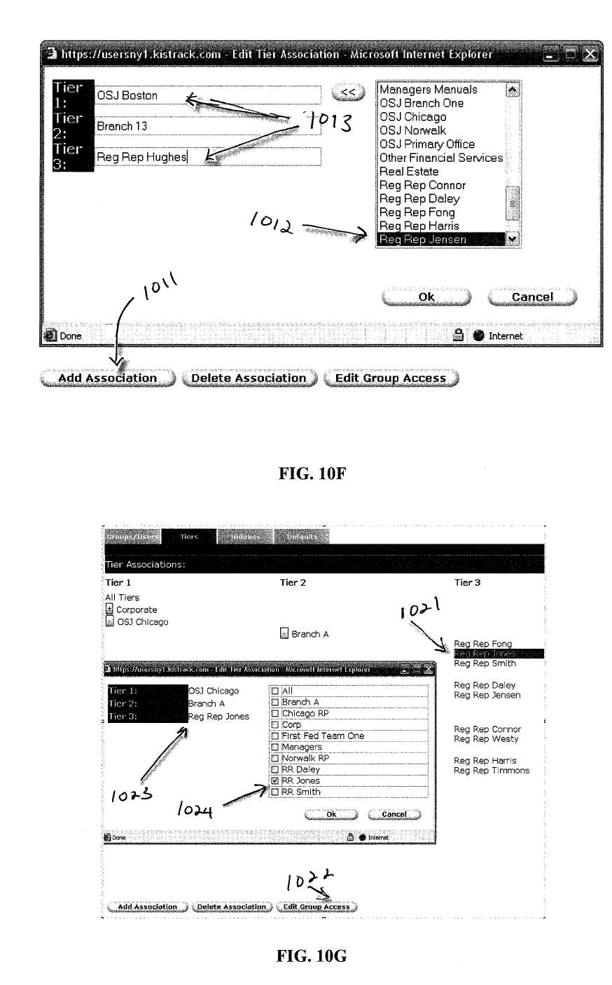

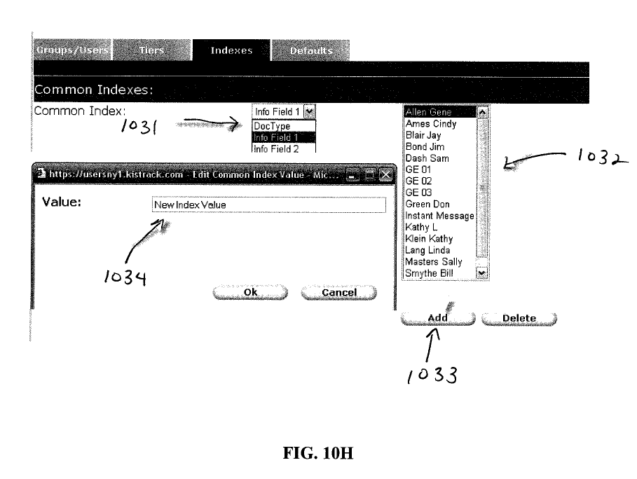

FIG. 10A illustrates the administration module of the system. To add a user, the client administrator accesses the administration module 1005. The Add Users function is selected 1010, which presents the client administrator with a dialog box that captures appropriate information regarding the personnel member (or secondary administrator). An exemplary dialog box for adding users and defining document access (i.e., security clearance) is illustrated in FIG. 10B. For example, the client administrator may enter PIN Codes, Security Codes (e.g., code 100 for Doc Retrieval Only; 600 for Retrieval and Data Collection Capabilities and/or the ability to alter workbasket routes; 900 for Administrator functions; 950 cash tracking availability).

The client administrator may then add that user to a Group, or create additional Groups at 1015. An exemplary dialog box for creating additional groups is illustrated in FIG. 10C. The client administrator may also populate the various Groups in Step 1020. Referring to FIG. 10D, the client administrator selects the Group to be populated (referenced as 1001), then places a check mark in the box for each user 1002 that is to belong to that Group 1001. The client administrator may also use this function to see all members of all Groups and all Groups to which the USER is a member.

In this manner, the system 10 permits a client administrator to define various hierarchies to which specified groups are given access. In this manner, the client administrator controls which personnel members see stored information. As explained above, the Tier data are hierarchically dependent on one another. Once defined by the client administrator, when a retrieval user selects data in the top level combination box, the second level combination box will only display data relative to the data selected in the top level. This scheme follows for all levels of combination boxes, and may apply to both the data collection and retrieval processes utilized by the system.

An exemplary, three-tier hierarchical structure is illustrated in FIG. 10E. In this structure, Group 1 sees all of Corporate. All the employees are members of Group 2 and, therefore, may see all company manuals, best practices documents etc. All managers are also members of Group 3 and see information designated specifically to manager level staff. Individual, registered representatives may be part of their own Group, which may include their administrative staff as well. The number of Tiers may include, but is not limited to, seven nested Tiers.

In Step 1025, the client administrator may create a First Tier structure. Referring to FIG. 10F, the client administrator chooses to Add Association 1011. A list of existing values is immediately displayed in List 1012. The administrator may then choose from the List 1012, or may dynamically add values to the Field 1013.

In a similar manner, a client administrator may assign values to existing tiers in Step 1035 of FIG. 10A. Specifically, the client administrator may choose the tier access point where the New Association is to be added, then chooses to Add Association. All existing superior hierarchical values are automatically filled in, and the client administrator either chooses from existing values or dynamically enters new data values as required.

The system 10 further permits the client administrator to assign Group Access in Step 1045. Referring to FIG. 10G, the client administrator may choose access control point 1021, and then chooses the Edit Group Access function 1022. The client administrator is presented with a display 1023 that shows the client administrator precisely which Tier access structure is about to be acted upon. The client administrator enters a check mark 1024 next to as many Groups as may require access at this point. Thus, in the example of FIG. 10G, Register Representative Jones is the sole member of GROUP RR JONES and will see all files acquired and designated for Jones's accounts in Branch A of the Chicago OSJ.

The client administrator may also add Common Tier Index Values in Step 1055. The system 10 may be adapted to support unlimited additional informational indexes called Common Indexes. These indexes will be shown to any personnel member who has access the Tiers that may be associated with the Common Indexes, but they can not be used for Access Control points. Referring to FIG. 10H the client administrator chooses the Common Tier 1031, displaying all existing values in display box 1032. The client administrator then selects the ADD function 1033 and chooses from existing values or adds new values in the Field 1034.

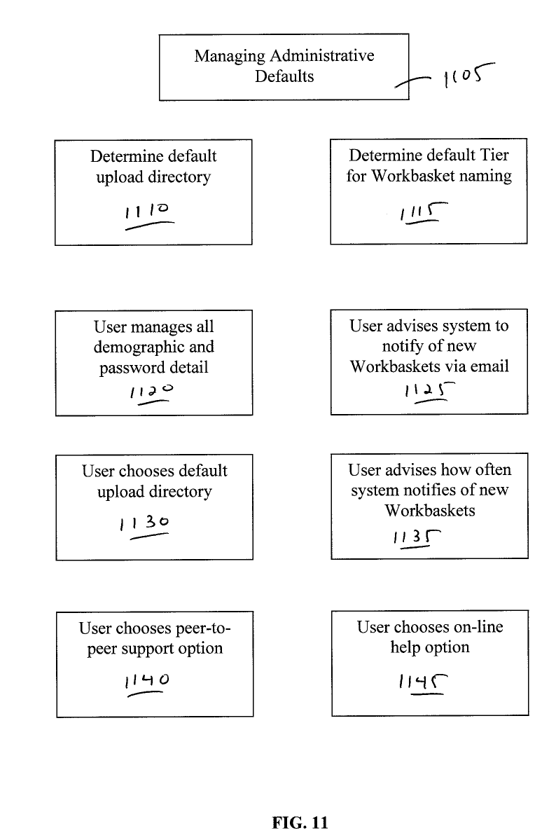

Management of administrative defaults is shown in FIG. 11. The client administrator determines which sub-directory is to be used for acquiring new scanned in images 1110. This will serve as the default when selecting the add documents function. The client administrator also determines which Tier or Common Index will be used as the default name when any new workbasket is created 1115. The client administrator may also manage personal preferences. The client administrator is able to maintain all personal information 1120, as well as control notification practices 1125 of the system 10. The client administrator can change the Data Collection Station defaults 1130, as well as tell the system how often they want to be notified of new workbaskets 1135. Help options may also be defined (1140, 1145).

The system is also configured to integrate payment information, tracking the information and correlating it with a workbasket. A cash tracking module may be configured to allow a check from a client to be imaged into a database (eliminating the need for depositing into a bank), so that the firm can take advantage of electronic check processing technologies. Thus, the cash tracking module allows a user to image the check, as well as allows an authorized individual to electronically process the check utilizing the system 10.

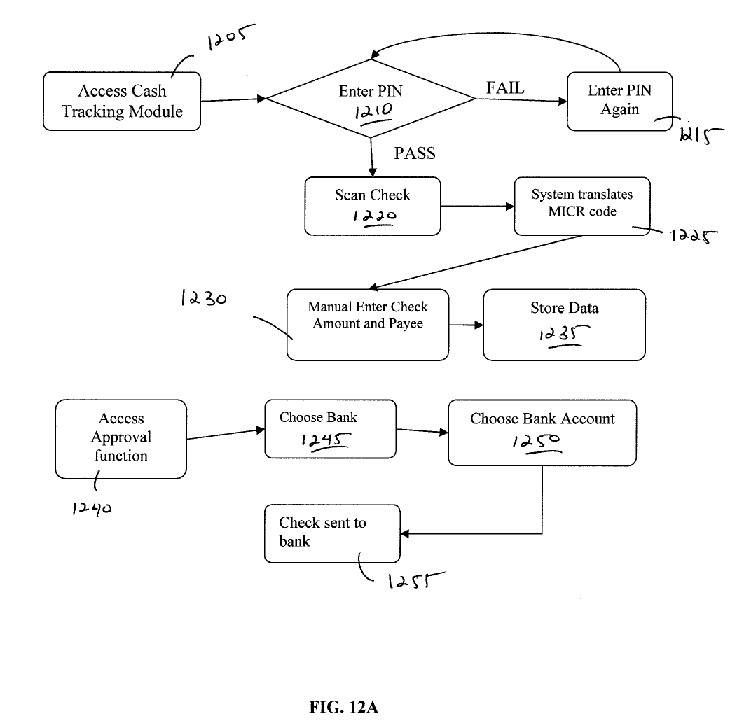

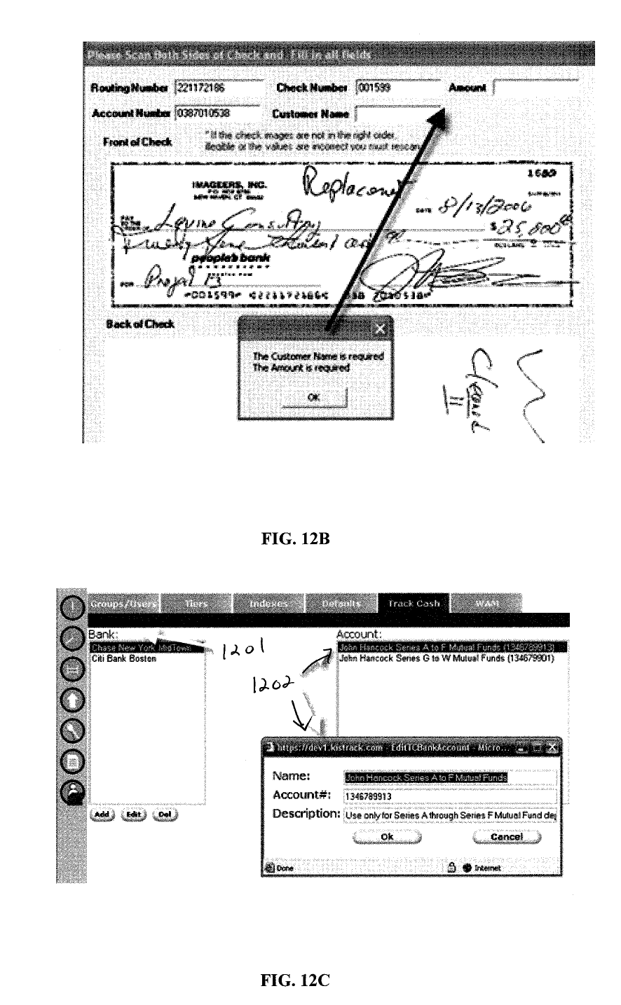

FIG. 12A illustrates flow diagram for processing payments in accordance with an embodiment of the present invention. As shown, a user (i.e., the personnel member or client administrator) accesses a cash tracking module at Step 1205, entering a PIN 1210. Should the PIN fail, the user is asked to enter the PIN again. If, however, the PIN is accepted, the user is directed to scan payment information and, in particular, a check at 1220. FIG. 12B illustrates the dialog box that opens once a check is scanned into the system 10. As shown, scanning check results in display of routing number, account number, and check number. Via the dialog box, at Step 1230, the user may then manually enter the check payment amount and customer name. This not only provides an additional level of payment validation, but also records the event that the user has authorized the check. In Step 1235, the resulting data is stored in the SQL database.

Once stored, the payment process may be approved. As shown in FIG. 12A, the user access the cash tracking module, selecting the Approval function 1240. Referring to FIG. 12C, the user selects the bank from drop down list (referenced as 1201), as well as the corresponding bank account from the dialog box (referenced as 1202). Choosing OK may then transmit the check, e.g., via CHECK21 or ACH networks, using pre-described data held in a SQL database.

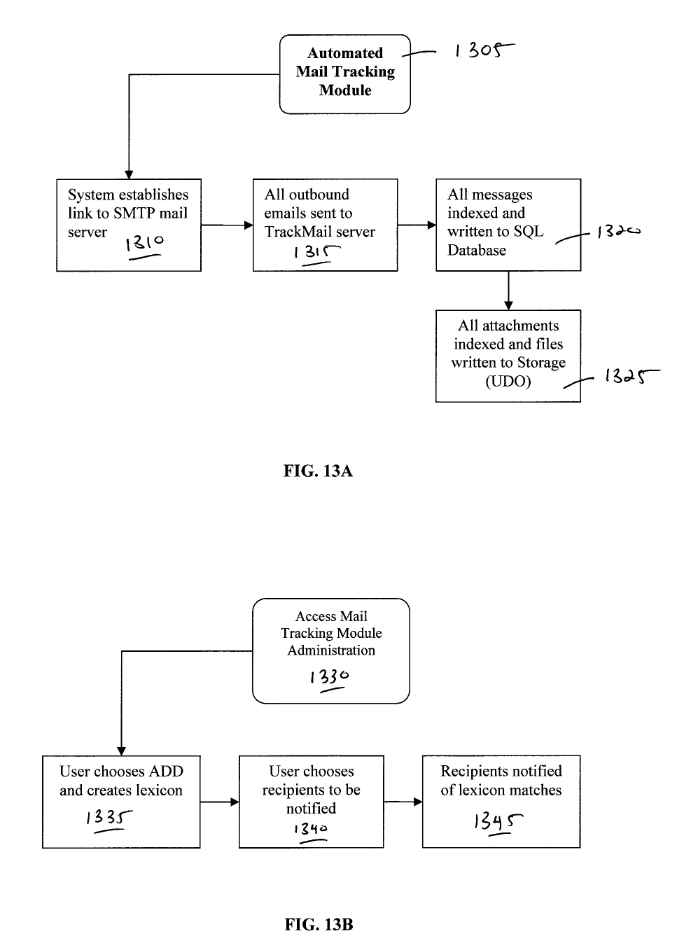

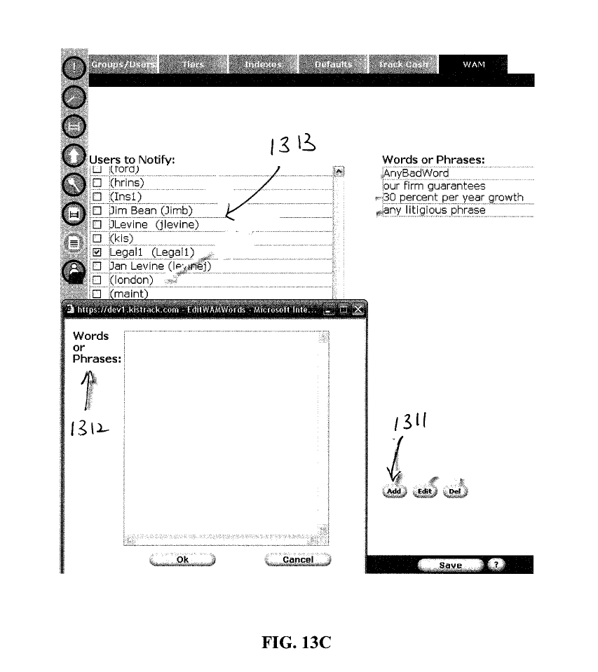

The system 10 may further include a mail tracking module integrated therein. The mail tracking function, called can be fully integrated with all other functions and modules of the system (such as workflow). FIG. 13A illustrates a flow chart for the processing in the mail tracking module of the system 10. As shown, once the mail tracking module is accessed 1305, the system 10 establishes an SMTP connection to client email server 1310. All outbound client messages are sent to the host server via a standard hotsync 1315 (e.g., a MICROSOFT Exchange Active Sync). All messages are then indexed by and written to the SQL database 1320. The index parameters include, but are not limited to categories such as: From, To, Date, Subject, and/or Content. Finally, all attachments are written to storage drive (e.g., the Ultra Density Optical Drive) and then full-text indexed for future searching 1325.

The mail tracking module further enables the system to notify users of various lexicons. Referring to FIG. 13B, a personnel member/client administrator accesses the mail tracking module, selecting the Administration function 1330. Referring to the dialog box illustrated in FIG. 13C, the personnel member/client administrator chooses the ADD feature 1311 and opens the lexicon input box 1312. In the lexicon input box 1312, personnel member/client administrator can add words or phrases the system is to identify (e.g., vulgar language, litigious phrases, etc.) 1335. Referring back to FIG. 13B, the personnel member/client administrator further designates recipients (referenced as 1313 in FIG. 13C) to be notified in the event of a lexicon match at Step 1340. Thus, when a lexicon match occurs, the designated recipients may be notified (via email) regarding: the originating email server and administrator, From/To/Subject information, the matches found in the body of the email, and/or the matches found in any attachment of the email.

With this configuration, the system 10 captures every piece of email that leaves a client's facility, including the associated attachments. The email is stored by sender and subject and then immediately analyzed for objectionable words or phrases that the client defines. Any offending email is immediately forwarded to an appropriate supervisor or compliance email address for review and all emails are searchable by authorized individuals by sender, date, and subject. Additionally, every word of the content is also searchable.

In a similar manner, the system 10 may perform a lexicon search on advertisements received by the client. An add tacking module may be integrated with the flow tracking module to provide automatic analysis of advertising copy to highlight unacceptable words or phrases. The add tacking module allows a workbasket to be established that contains new advertising copy. The workbasket can be initiated by an outside ad agency that is producing the initial copy and routed to ad managers and registered principals for review and approval. All copy changes are captured as ads are approved or sent back for additional work. The ad tacking module also feeds ad copy into the NASD Advertising review system (AREF).

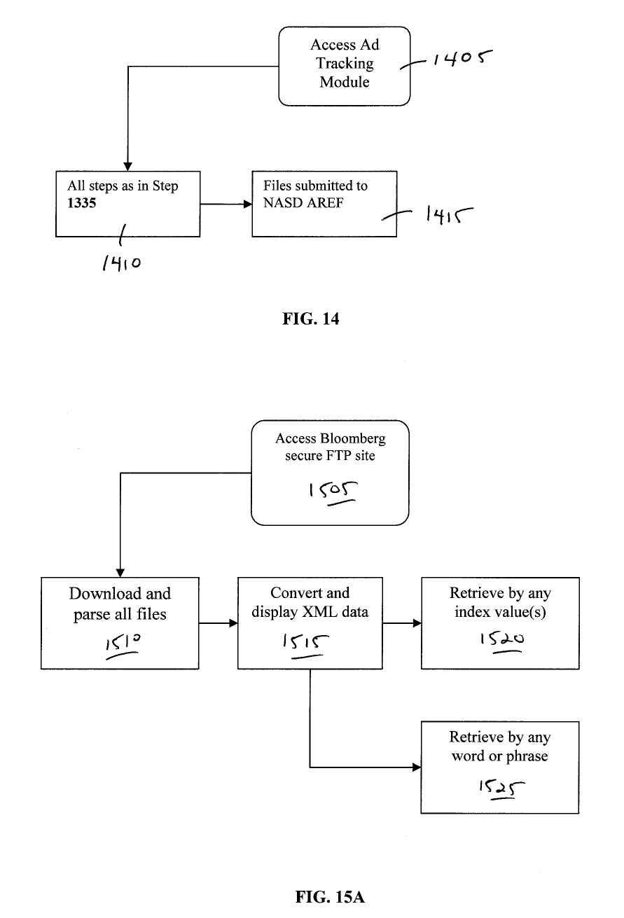

FIG. 14 illustrates a flow chart of the ad tacking module of the system. As illustrated, a user accesses the add tacking module 1405, with the personnel member/client administrator adding words or phrases for the system to identify (e.g., vulgar language, litigious phrases, etc.) 1410. The advertising person submits the copy to be analyzed as an attachment to an email, and any matches against the lexicon will result in the same notification procedures as in Step 1345. Once analyzed, the advertising copy may be submitted to NASD's Advertising Regulation Electronic Files (AREF) system (Step 1415).

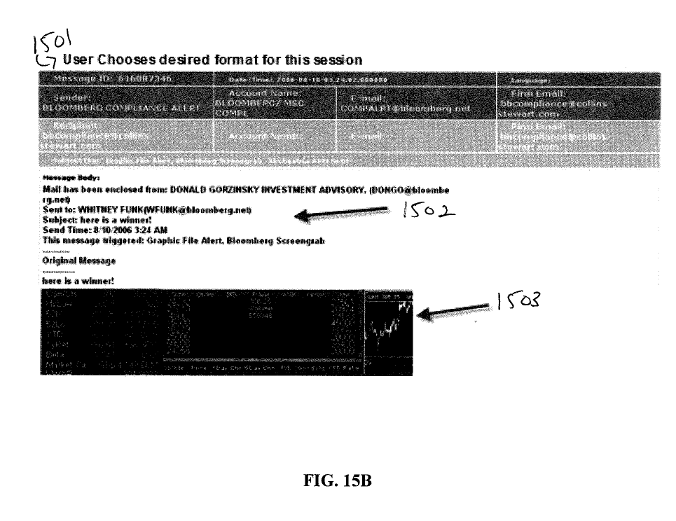

The system may further track a client's activity on such that it is integrated with the workflow process. FIG. 15A is a flow chart of a file tracking feature. In Step 1505, the invention accesses Bloomberg's secure FTP site and exchanges client credentials for access to a specific client's activity for that day. Then, when files are fully downloaded in the various formats (e.g., BLOOMBERG formats such as instant messages, email and internet mail) and then parsed into a SQL database 1510. Then the XML data is converted and displayed in customized formats of each client 1515. FIG. 15B illustrates an exemplary format (referenced as 1501) and may include at least the email or IM body (references as 1502), as well as any attachments (referenced as 1503).

Referring back to FIG. 15A, all data in any field is available to be retrieved by industry standard drop down or text boxes 1520. In addition, all data in any field and in any attachment is available to be full text searched by any word or phrase as in Step 1525.

While the present invention has been described in detail and with reference to specific embodiments thereof, it will be apparent to one skilled in the art that various changes and modifications can be made therein without departing from the spirit and scope thereof. For example, the end user and server computer systems may be implemented by any personal or other type of computer system (e.g., native WINDOWS, etc.). The computer systems may include any commercially available operating system (e.g., native WINDOWS, etc.). The computer systems may further include any commercially available or custom software (e.g., server software, browser software, etc.), and any types of input devices (e.g., keyboard, mouse, voice recognition, etc.). It is to be understood that the software for business process management of the present invention may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control.

The computer systems may alternatively be implemented by hardware or other processing circuitry. The various functions of the business process management system may each be distributed in any manner among any quantity (e.g., one or more) of hardware and/or software modules or units, computer or processing systems or circuitry, where the computer or processing systems may be disposed locally or remotely of each other and communicate via any suitable communications medium (e.g., LAN, WAN, Intranet, Internet, hardwire, modem connection, wireless, etc.). The software, algorithms, tests and/or activities described above and/or illustrated in the flow charts may be modified in any manner that accomplishes the functions described herein.

The network may be implemented by any communications network (e.g., LAN, WAN, Internet, Intranet, etc.), while the server and end user computer systems may include any conventional or other communications devices to communicate over the network. The screening and therapy tools of the present invention may each be implemented by any quantity of computer systems, and may each reside and/or be executed on the server, end-user or other third-party computer system or any combination of these computer systems. The various modules may each be available on recorded medium (e.g., floppy diskettes, CD-ROM, memory devices, etc.) for use on systems connected by a network, or may each be downloaded (e.g., in the form of carrier waves, packets, etc.) to systems from a network.

The screens for the software (e.g., the modules) may be displayed and arranged in any fashion and include any desired information. The screens may request and/or receive any desired information from a user (e.g., bibliographic information, physical information, personal information, etc.). Each screen may include any quantity of links, buttons, or other input symbols including any desired labels (e.g., help, close, ready, check it, etc.). The modules may employ any quantity of screens or other input mechanisms (e.g., prompts, menus, windows, etc.), where these input devices may interact with users via any input devices (e.g., mouse, keyboard, voice recognition, touch screen, etc.). The screens may be presented or navigated in any order or fashion.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

1. A system for managing business processes comprising:
a computer system accessible via a network operable to:
manage access by a plurality of users to documents;
enable dynamic generation of a workflow process by the plurality of users;
execute and monitor the workflow process;
maintain information about the workflow;
process a payment related to the workbasket; and
capture email content sent through the system.

2. (canceled)

3. In a computer system accessible via a network that manages access by a plurality of individual users to files in the course of dynamically generating, executing, and monitoring a workflow process, a method comprising:
(a) generating data describing a workflow route that defines workflow parameters for managing a businesses process;
(b) generating data describing a workbasket including work to be performed during the workflow route;
(c) designating a first user of the plurality of individual users to be capable of accessing the workbasket at a first point along the workflow route;
(d) designating a second user of the plurality of individual users to be capable of accessing the workbasket at a second point along the first workflow route; and
(e) initiating the workflow route by adding data representing a file to the workbasket.

4. The method of claim 3, wherein the files are added to a workbasket by scanning a paper document or uploading a digital file.

5. The method of claim 3 further comprising (f) selectively directing the workbasket to one of the first user and the second user.

6. The method of claim 5 further comprising notifying the first and/or second user via email when access to a workbasket has been granted.

7. The method of claim 3 further comprising indexing the files added to the workbasket via a library of predetermined index values, wherein the index values present interactive data fields to each of the plurality of users.

9. The method of claim 3 further comprising scanning the characters of each file as it is added to the workbasket.

10. The method of claim 3 further comprising (f) processing a payment related to the workbasket.

11. The method of claim 10, wherein (f) comprises:
(f.1) entering payment information; and
(f.2) transmitting the payment.

12. The method of claim 11, wherein (f.1) entering comprises scanning an image of a check to display account information, and (f.2) transmitting comprises electronically transmitting the check to tender payment.

13. The method of claim 10 further comprising (g) capturing email content sent through the system.

14. The method of claim 13, wherein (g) capturing comprises:
(g.1) scanning outbound messages sent from an email server to identify characters contained within the messages;
(g.2) indexing the messages via predetermined index parameters; and
(g.3) writing all e-mail attachments to a storage device.

15. The method of claim 13, further comprising (g.4) generating a notification when a predetermined character is identified.

16. The method of claim 13, further comprising:
(h.1) scanning inbound messages and/or attachments to the messages received by the email server to identify characters contained within the messages and/or attachments; and
(h.2) generating a notification when a predetermined character is identified.

17. A computer readable medium encoded with instructions, that when executed by a computer, cause the computer to manage access by a plurality of individual users to files in the course of dynamically generating, executing, and monitoring a workflow process comprising:
(a) generating data describing a workflow route that defines workflow parameters for managing a businesses process;
(b) generating data describing a workbasket including work to be performed during the workflow route;
(c) designating a first user of the plurality of individual users to be capable of accessing the workbasket at a first point along the workflow route;
(d) designating a second user of the plurality of individual users to be capable of accessing the workbasket at a second point along the first workflow route; and
(e) initiating the workflow route by adding data representing a file to the workbasket.
